(19) United States
(12) Patent Application Publication
(10) Pub. No.: US 2026/0221741 A1
(43) Pub. Date: Jul. 30, 2026

(54) TORQUE TUBE CABLE HANGER

(71) Applicant: Hubbell Incorporated, Shelton, CT (US)

(72) Inventor: Greg Patrick Roccapriore, Bath, NH (US)

(21) Appl. No.: 19/464,925

(22) Filed: Jan. 30, 2026

Related U.S. Application Data
(60) Provisional application No. 63/751,452, filed on Jan. 30, 2025.

(51) Int. Cl. H02G 3/04

(52) U.S. Cl. CPC H02G 3/0456

(57) ABSTRACT

A cable hanger that includes a first section, a second section, and an intermediate section that extends between the first section and the second section. The first section can be secured to a support and the second section can support a cable. The first section can translate along the support. The intermediate section can space the second section away from the support to avoid interfering with the translation of the first section.

### CROSS-REFERENCE TO RELATED APPLICATION

This application claims the benefit of U.S. Provisional Application No. 63/751,452, filed Jan. 30, 2025, the entire contents of which is incorporated herein by reference in its entirety.

### FIELD

The present disclosure relates to a cable hanger. More particularly, the present disclosure relates to cable hanger for maintaining cables distal to torque tube brackets.

### BACKGROUND

Solar panel systems are installed with a mounting structure to support various panels and other components. Electrical cables are also installed between the various panels and other components. A cable hanger for supporting the electrical cables may be coupled to the mounting structure.

Other components may include brackets or other components coupled to an outer surface of the mounting structure. The brackets may limit or prevent compact cable hangers that support the cables close to the mounting structure from moving along the mounting structure. Therefore, a need exists for a cable hanger that supports the cables in a manner that does not block or limit the movement of the cable hanger along the mounting structure.

### SUMMARY

Various examples of the present disclosure can overcome various of the aforementioned and other disadvantages associated with known cable hangers and offer new advantages as well.

According to one aspect of various examples of the present disclosure there is provided a cable hanger that includes a first section that can be secured to a support, a second section that can support a cable, and an intermediate section that extends between the first section and the second section. The first section can be secured to a support and the second section can support a cable. The first section can translate along the support. The intermediate section can space the second section away from the support to avoid interfering with the translation of the first section. The second section includes a third vertical section, a fourth vertical section parallel to the third vertical section, a second connecting section that extends between a first end of the third vertical section and a first end of the fourth vertical section, and an inclined section formed as a cantilever member from a second end of the fourth vertical section. The first can translate along the support. The intermediate section can space the second section away from the support to avoid interfering with the translation of the first section.

According to one aspect of various examples of the present disclosure there is provided a method for supporting cables against a support. The method includes positioning a cable hanger proximate to the support. The cable hanger includes a first section, a second section, and an intermediate section that extends between the first section and the second section. The method also includes connecting the first section to the support and receiving the cables within the second section. The method further includes translating the first section along a length of the support. The second section is spaced apart from the support by the intermediate section and does not interfere with the translation of the first section.

According to one aspect of various examples of the present disclosure there is provided a method for supporting cables against a support. A cable hanger is positioned proximate to the support. The cable hanger includes a first section that has an open perimeter and can be secured to a support, and a second section coupled to the first section and has a selectively enclosed perimeter. The second section can support a cable. The first section is flexed from a first position to a second position to fit around the support. The perimeter of the first section is smaller than a cross section of the support in the first position. The cables are received within the second section. The first section is translated along a length of the support. The second section is positioned at least partially away from the first section to avoid interfering with the translation of the first section.

According to another aspect of various examples of the present disclosure, there is provided a cable hanger that includes a first section, a second section, and an intermediate section that extends between the second vertical section and the third vertical section. The first section includes a first vertical section, a second vertical section parallel to the first vertical section, and a first connecting section that extends between a first end of the first vertical section and a first end of the second vertical section. The second section can support a cable and includes a third vertical section, a fourth vertical section parallel to the third vertical section, a second connecting section that extends between a first end of the third vertical section and a first end of the fourth vertical section, and an inclined section formed as a cantilever member from a second end of the third vertical section. The intermediate section extends between the second vertical section and the third vertical section. The first section can translate along the support. The intermediate section can space the second section away from the support to avoid interfering with the translation of the first section.

According to another aspect of various examples of the present disclosure, there is provided a cable hanger that includes a first section and a second section. The first section has an open perimeter and can be secured to a support. The second section is coupled to the first section and has a selectively enclosed perimeter. The second section can support a cable. The first section can translate along the support. The second section is positioned at least partially away from the first section to avoid interfering with the translation of the first section.

The disclosure herein should become evident to a person of ordinary skill in the art given the following enabling description and drawings. The drawings are for illustration purposes only and are not drawn to scale unless otherwise indicated. The drawings are not intended to limit the scope of the disclosure. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred examples and reference to the accompanying drawing wherein:

FIG. 1 is a perspective view of a cable hanger.

FIG. 2 is a front view of the cable hanger of FIG. 1.

FIG. 3 is a top view of the cable hanger of FIG. 1.

FIG. 4 is a bottom view of the cable hanger of FIG. 1.

FIG. 5 is a right view of the cable hanger of FIG. 1.

FIG. 6 is a left view of the cable hanger of FIG. 1.

FIG. 7 is a perspective view of the cable hanger of FIG. 1 coupled to a torque tube and supporting cables.

FIG. 8 is a perspective view of an alternate cable hanger.

FIG. 9 is a front view of the cable hanger of FIG. 8.

FIG. 10 is a back view of the cable hanger of FIG. 8.

FIG. 11 is a top view of the cable hanger of FIG. 8.

FIG. 12 is a bottom view of the cable hanger of FIG. 8.

FIG. 13 is a right view of the cable hanger of FIG. 8.

FIG. 14 is a left view of the cable hanger of FIG. 8.

### DETAILED DESCRIPTION

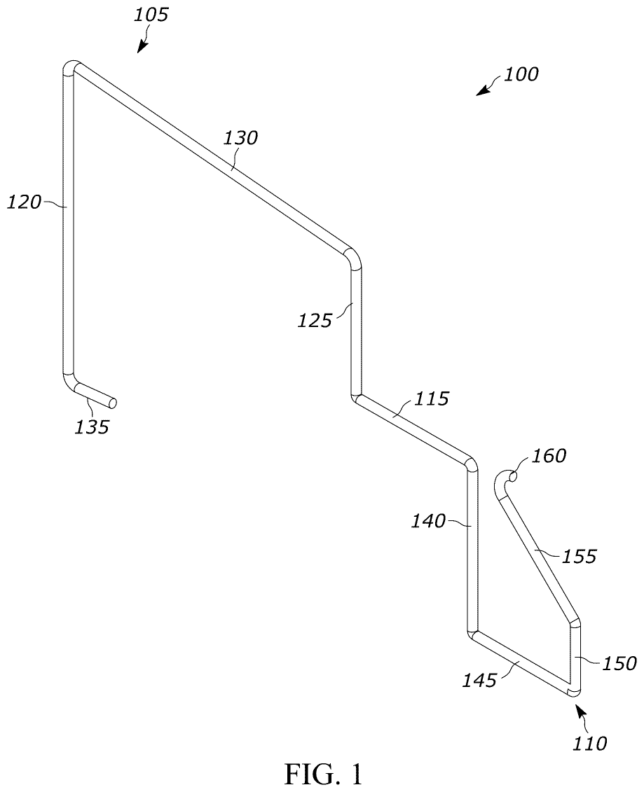

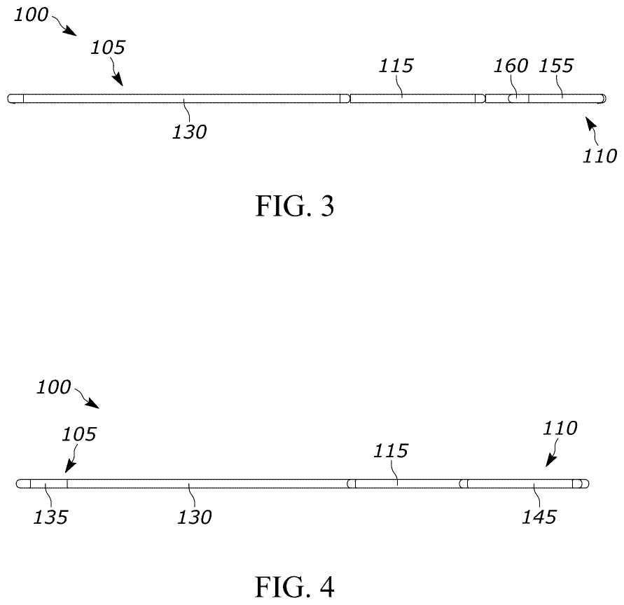

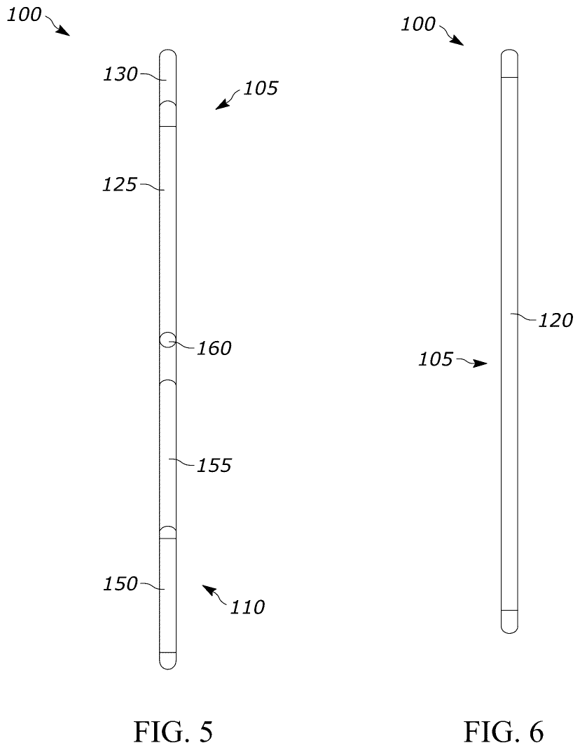

As shown in FIGS. 1 to 6 illustrate a cable hanger 100 for supporting electrical cables. The cable hanger 100 may be constructed from a substantially rigid material (e.g., metal, plastic, etc.). The rigid material may assist the cable hanger 100 in maintaining its shape.

In some forms, the cable hanger 100 may be integrally formed in a one-piece construction. In other examples, two or more sections of the cable hanger 100 may be coupled together to form the cable hanger 100.

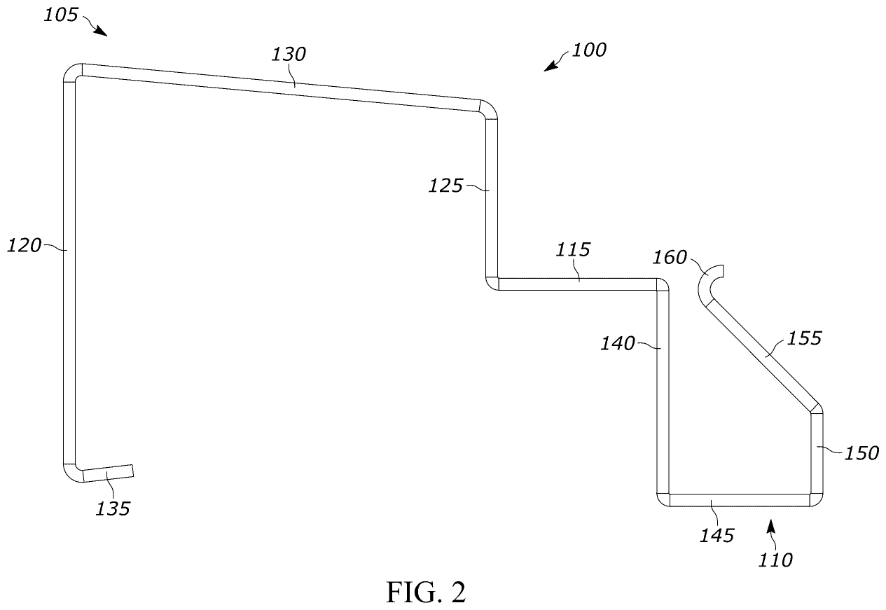

As shown in FIG. 2, the cable hanger 100 may include a first section 105, a second section 110, and an intermediate section 115 that extends between the first and second sections 105, 110. The illustrated first section 105 may be larger than the second section 110. However, other examples may include a second section 110 that is equal to or larger than the first section 105.

With continued reference to FIG. 2, the first section 105 may include a first vertical rod 120, a second vertical rod 125, a first inclined rod 130, and a second inclined rod 135. The first vertical rod 120 and the second vertical rod 125 may be spaced apart from one another and oriented parallel to one another.

The first inclined rod 130 may be connected to a first end of the first vertical rod 120 and the second inclined rod 135 may be connected to a second end of the vertical rod opposite to the first end. The first inclined rod 130 may extend between the first and second vertical rods 120, 125. The second inclined rod 135 may be formed as a cantilever member relative to the second end.

In some forms, the first vertical rod 120 may be longer than the second vertical rod 125. Additionally, or in the alternative, the second vertical rod 125 may not extend to a plane parallel to the end of the first vertical rod 120. As viewed in FIG. 2, the upper end of the first vertical rod 120 may extend beyond the upper end of the second vertical rod 125. The first inclined rod 130 may extend at an inclined (e.g., oblique) angle between the two upper ends.

In some forms, both the first and second inclined rods 130, 135 may be oriented obliquely with respect to the first vertical rod 120. In the illustrated example, the first and second inclined rods 130, 135 may extend at reciprocal angles relative to the first vertical rod 120. In other words, the first and second inclined rods 130, 135 may extend at the same angle but in a different direction so that an axis through each of the first and second inclined rods 130, 135 will intersect. For example, the first and second inclined rods 130, 135 may extend at an angle between about 1° and about 89°. The first and second inclined rods 130, 135 may extend at an angle between about 5° and about 80°. The first and second inclined rods 130, 135 may extend at an angle between about 10° and about 75°. The first and second inclined rods 130, 135 may extend at an angle between about 15° and about 60°. The first and second inclined rods 130, 135 may extend at an angle between about 20° and about 45°. The first and second inclined rods 130, 135 may extend at an angle of about 30°. In other examples, the first inclined rod 130 may extend at a different angle (e.g., larger or smaller) than the second inclined rod 135. In still other examples, the first inclined rod and/or the second inclined rod 135 may extend perpendicularly with respect to the first vertical rod 120.

In some forms, the second inclined rod 135 may be shorter than the first inclined rod 130. For example, the second inclined rod 135 may be less than about 75% of the length of the first inclined rod 130. The second inclined rod 135 may be less than about 50% of the length of the first inclined rod 130. The second inclined rod 135 may be less than about 25% of the length of the first inclined rod 130. In another example, the second inclined rod 135 may not intersect an axis that extends along a length of the second vertical rod 125.

With continued reference to FIG. 2, the second section 110 may include a third vertical rod 140 that is spaced apart from the second vertical rod 125 and is parallel to both the first and second vertical rods 120, 125. In the illustrated example, the lower end of the third vertical rod 140 may be approximately coplanar with the lower end of the first vertical rod 120 (e.g., the end with the second inclined rod 135). The third vertical rod 140 may be shorter in length than the first vertical rod 120 and may not extend to the upper end of the first vertical rod (e.g., the end with the first inclined rod 130). However, the length and/or position of the third vertical rod 140 may be different in other examples. For example, the third vertical rod 140 may be inclined and obliquely oriented related to the first and/or second vertical rods 120, 125 as illustrated in FIG. 6 without departing from the scope of the disclosure.

In some forms, a horizonal rod 145 may extend from a lower end of the third vertical rod 140. The horizontal rod 145 and the third vertical rod 140 may be substantially perpendicular with respect to each other, although the horizontal rod 140 may be inclined relative to the third vertical rod 140 in other examples.

In some forms, a fourth vertical rod 150 may extend from the other end of the horizontal rod 145. In the illustrated example, the fourth vertical rod 150 may be parallel to the third vertical rod 140 and may be perpendicular to the horizontal rod 145. The fourth vertical rod 150 may be shorter than the third vertical rod 140 (although it may be equal to or longer than the third vertical rod 140 in other examples).

In some forms, a third inclined rod 155 may extend as a cantilever member from the fourth vertical rod 150 toward the third vertical rod 140. For example, the third inclined rod 155 may extend toward an upper end of the third vertical rod 140. The free end of the third inclined rod 155 may be spaced apart from the upper end of the third vertical rod 140.

In some forms, the inclination of the third inclined rod 155 may be different than the inclination of the first and/or second inclined rods 130, 135. For example, angle between the third inclined rod 135 and the fourth vertical rod 150 may be greater than the angle between the first vertical rod 120 and the first inclined rod 130. In other example, the inclination angle between the various rods may be different.

In certain forms, the free end of the third inclined rod 155 may include a curved or hooked portion 160. The illustrated hooked portion 160 may be substantially semicircular in shape, although it may extend a different angular distance in other examples.

With continued reference to FIG. 2, the intermediate section 115 may extend between the first and second sections 105, 110. For example, the intermediate section 115 may extend between a lower end of the second vertical rod 125 and the upper end of the third vertical rod 140. In the illustrated example, the intermediate section 115 may be a horizontal rod that is parallel to the horizontal rod 145. Therefore, the intermediate section 115 may be perpendicular to both the second and third vertical rods 125, 140. In other examples, the intermediate section 115 may be oblique relative to the second and third vertical rods 125, 140.

In use, the cable hanger 100 may be coupled to a support or torque tube 50. The illustrated torque tube 50 may have a substantially rectangular cross section, although other examples may have different shapes. The torque tube 50 may include a hollow central portion.

The cable hanger 100 may be positioned so that the first section 105 is proximate to the torque tube 50. For example, the width between the first and second vertical rods 120, 125 may be approximately a width of the torque tube 50. In some forms, a technician may slide the first section 105 over an end of the torque tube 50. In other examples, the technician may flex the first section 105 so that the first vertical rod 120 fits over and around the torque tube 50 (e.g., when the ends of the torque tube 50 are blocked).

In some forms, the distance between the first and second inclined rods 130, 135 may be less than the height of the torque tube 50. For example, the height of the first vertical rod 120 may be approximately the height of the torque tube 50 but the inclined rods 130, 135 extend toward each other so that the distance between the free end of the second inclined rod 135 and the first inclined rod 130 may be less than the height of the torque tube 50.

In certain forms, the first and second inclined rods 130, 135 may be flexible. For example, the first and/or second inclined rods 130, 135 may move away from the neutral position illustrated in FIG. 2 toward a horizontal position (e.g., a position parallel to the horizontal rod 145). Contact with the torque tube 50 may cause this movement. As the first and second inclined rods 130, 135 move away from their respective neutral positions, they may move apart a distance that is sufficient to receive the height of the torque tube 50. The bias of the inclined rods 130, 135 may be back toward the respective neutral positions, which may assist the first section 105 to grip against the torque tube 50.

With continued reference to FIG. 6, the second section 110 may be spaced apart from the torque tube 50 when the first section 105 is received around the torque tube 50. For example, the intermediate section 115 may extend away from the first section 105 thereby spacing the second section 110 away from the torque tube 50.

The interior space of the second section 110 may support one or more cables 75 (e.g., electrical conductors). For example, the cables 75 may be inserted into the space through the opening between the hooked portion 160 and the third vertical rod 140 (which in the illustrated example may be inclined). The cables 75 may then rest on the horizontal rod 145.

In some forms, the technician may move the hooked portion 160 to fit around the third vertical rod 140. This may help to retain the cables 75 within the second section 110 and limit inadvertent removal.

The first section 105 may be able to move (e.g., translate) along the length of the torque tube 50. The torque tube 50 may include brackets or other projections that extend from its surface. The intermediate section 115 may have a length that spaces the second section 110 further away from the torque tube 50 than a maximum width of the projections or brackets. In this way, the first section 105 may move along the torque tube 50 without interference from the second section 110. More specifically, the cable hanger 100 may move to adjust the position of the supported cables 75 without substantial interference from the torque tube 50.

In some forms, a casing or sleeve may be disposed on one or more sections of the cable hanger 100. For example, some examples of the cable hanger 100 may include a sleeve on the horizontal portion 145. The sleeve may be constructed from a insulative material, which may help to further limit electrical conduction through the cable hanger 100.

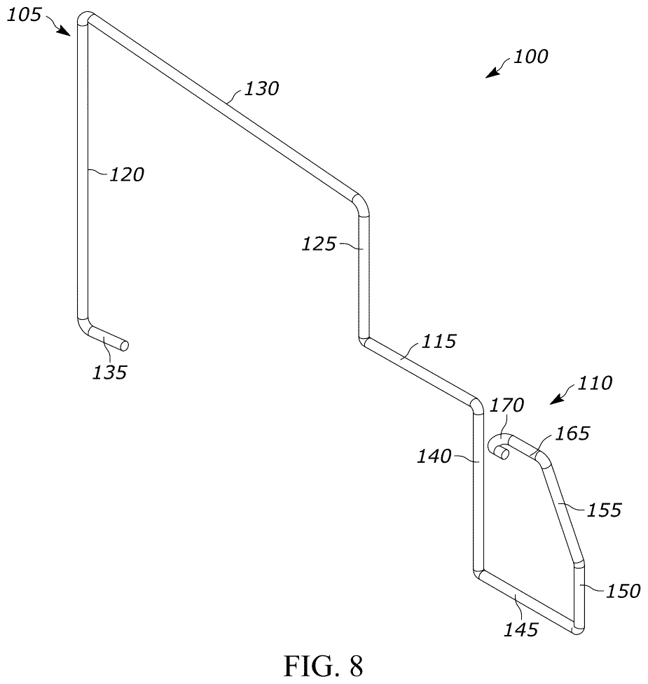

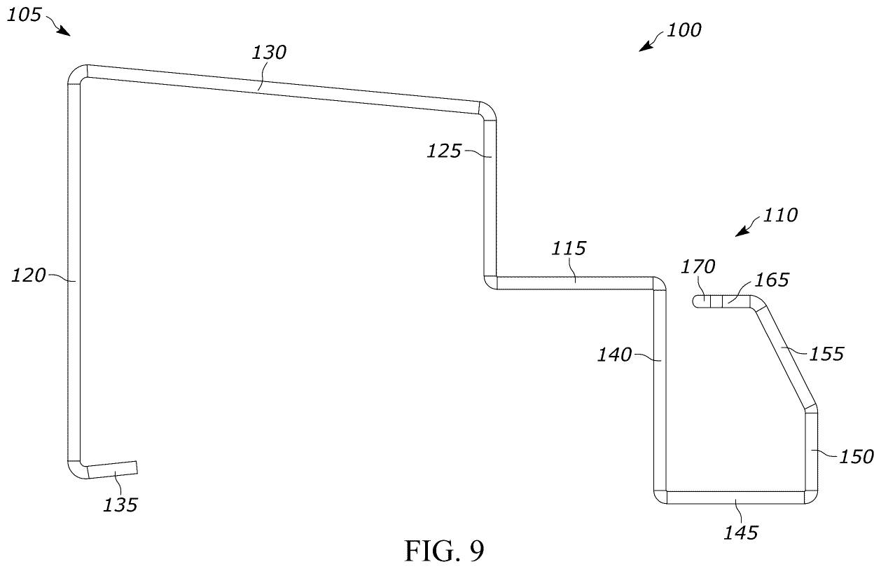

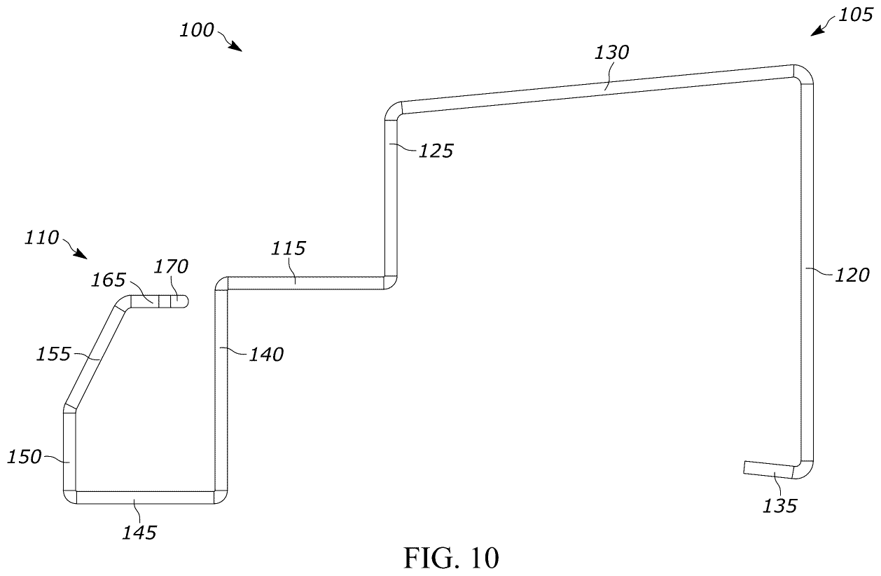

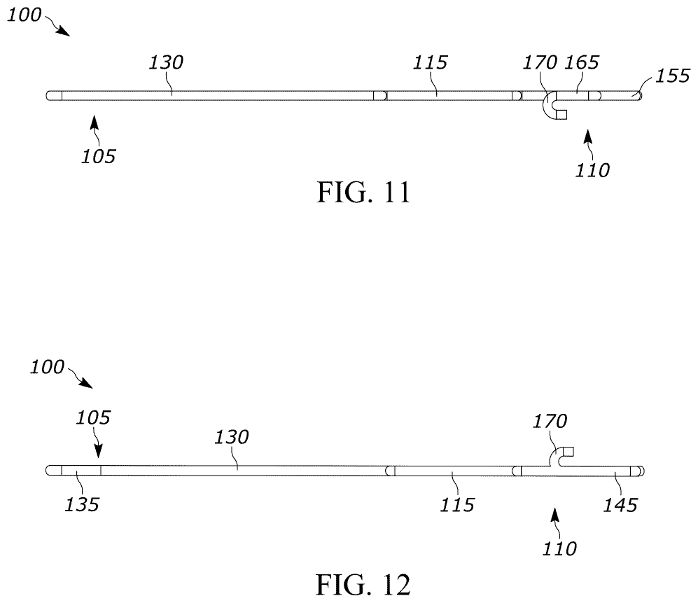

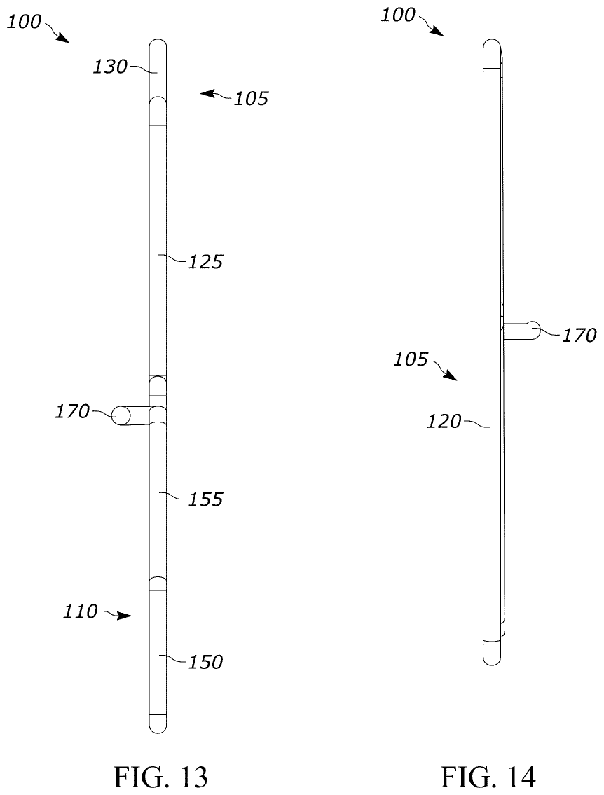

FIGS. 8 to 14 illustrate an alternate example of a cable hanger 100, which may be substantially similar to the above-described cable hanger 100. Only some similarities and differences are described below.

In some forms, the horizontal portion 145 may be a first horizontal portion and the cable hanger 100 may further include a second horizontal portion 165. The second horizontal portion 165 may be formed between the third inclined rod 155 and the hooked portion 170. The second horizontal portion 165 may disposed the hooked portion 170 closer to the third vertical portion 140.

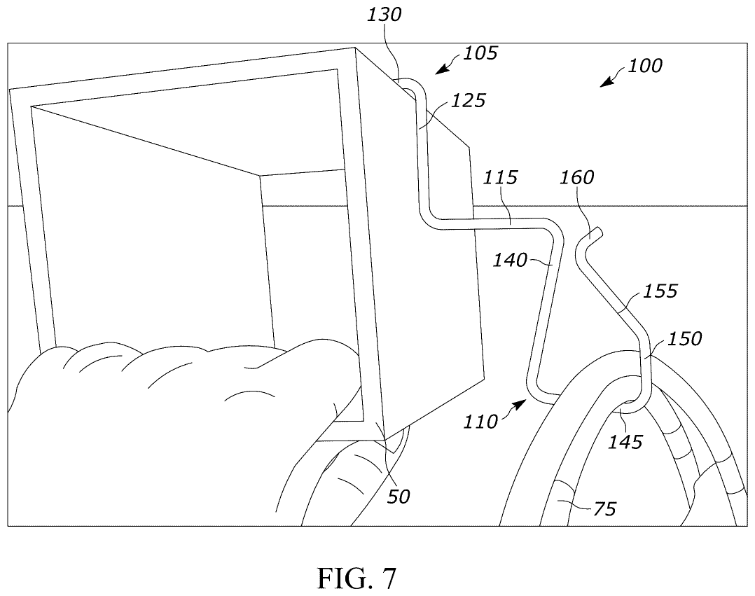

In some forms, the hooked portion 170 may be oriented approximately 90 degrees with respect to the hooked portion 160 in the cable hanger 100 of FIGS. 1 to 7. The orientation of the hooked portion 170 may assist in aligning the hooked portion 170 with the third vertical rod 140 so that the hooked portion 170 can engage the third vertical rod 140 so that the second section 110 includes a substantially closed perimeter. The closed perimeter of the second section 110 may limit the cables 75 from inadvertently exiting the second section 110. A technician may disengage the hooked portion 170 from the third vertical rod 140 to reopen the perimeter and remove the cables 75.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein. Those skilled in the art will also appreciate that various adaptations and modifications of the above-described preferred examples can be configured without departing from the scope and spirit of the disclosure. Therefore, it is to be understood that, within the scope of the appended claims, the disclosure may be practiced other than as specifically described.

1. A cable hanger comprising:
a first section configured to be secured to a support;
a second section configured to support a cable; and
an intermediate section that extends between the first section and the second section;
wherein the first section is configured to translate along the support; and
wherein the intermediate section is configured to space the second section away from the support to avoid interfering with the translation of the first section.

2. The cable hanger of claim 1, wherein the first section includes:
a first vertical section;
a second vertical section parallel to the first vertical section;
a first connecting section that extends between a first end of the first vertical section and a first end of the second vertical section; and
a second connecting section that is formed as a cantilever member from a second end of the first vertical section;
wherein a second end of the second vertical section is coupled to the intermediate section.

3. The cable hanger of claim 2, wherein the first connecting section is oriented obliquely with respect to the first vertical section and the second vertical section.

4. The cable hanger of claim 2, wherein the first connecting section is formed at a first angle with the first vertical section and the second connecting section is formed at a second angle with the first vertical section, and wherein the first angle and the second angle are reciprocal angles.

5. The cable hanger of claim 2, wherein the first vertical section extends along a first axis between a first plane and a second plane, wherein the second vertical section extends along a second axis parallel to the first axis, and wherein the second vertical section does not intersect the first plane or the second plane.

6. The cable hanger of claim 1, wherein the second section includes:
a first vertical section;
a second vertical section parallel to the first vertical section;
a first connecting section that extends between a first end of the first vertical section and a first end of the second vertical section; and
an inclined section formed as a cantilever member from a second end of the second vertical section;
wherein the inclined section extends toward the first vertical section.

7. The cable hanger of claim 6, wherein a free end of the inclined section includes a hook portion, and wherein the hook portion is configured to selectively engage the first vertical section for form a closed perimeter of the second section.

8. The cable hanger of claim 1, wherein an insulative sleeve is coupled to at least one of the first section, the second section, and the intermediate section.

9. The cable hanger of claim 1, wherein the first section, the second section, and the intermediate section are integrally formed as a one-piece construction.

10. A cable hanger comprising:
a first section configured to be secured to a support, wherein the first section includes;
a first vertical section;
a second vertical section parallel to the first vertical section;
a first connecting section that extends between a first end of the first vertical section and a first end of the second vertical section;
a second section configured to support a cable, wherein the second section includes,
a third vertical section;
a fourth vertical section parallel to the third vertical section;
a second connecting section that extends between a first end of the third vertical section and a first end of the fourth vertical section; and
an inclined section formed as a cantilever member from a second end of the third vertical section; and
an intermediate section that extends between the second vertical section and the third vertical section;
wherein the first section is configured to translate along the support; and
wherein the intermediate section is configured to space the second section away from the support to avoid interfering with the translation of the first section.

11. The cable hanger of claim 10, wherein an insulative sleeve is coupled to at least one of the first section, the second section, and the intermediate section.

12. The cable hanger of claim 10, wherein the first section, the second section, and the intermediate section are integrally formed as a one-piece construction.

13. The cable hanger of claim 10, wherein a third connecting section is formed as a cantilever member from a second end of the first vertical section, wherein the first connecting section is formed at a first angle with the first vertical section and the third connecting section is formed at a second angle with the first vertical section, and wherein the first angle and the second angle are reciprocal angles.

14. The cable hanger of claim 10, wherein the first vertical section extends along a first axis between a first plane and a second plane, wherein the second vertical section extends along a second axis parallel to the first axis, and wherein the second vertical section does not intersect the first plane or the second plane.

15. The cable hanger of claim 10, wherein a free end of the inclined section includes a hook portion, and wherein the hook portion is configured to selectively engage the third vertical section for form a closed perimeter of the second section.

16. A method for supporting cables against a support, the method comprising:
positioning a cable hanger proximate to the support, wherein the cable hanger includes,
a first section;
a second section; and
an intermediate section that extends between the first section and the second section;
connecting the first section to the support;
receiving the cables within the second section; and
translating the first section along a length of the support;
wherein the second section is spaced apart from the support by the intermediate section and does not interfere with the translation of the first section.

17. The method of claim 16, wherein the first section includes a first vertical rod, a second vertical rod parallel to the first vertical rod, a first connecting rod that extends obliquely between the first vertical rod and the second vertical rod, the method further comprising:
prior to connecting, bending the first connecting rod from a neutral position to a mounting position substantially perpendicular to the first vertical rod and to the second vertical rod;
wherein the first connecting rod is biased toward the neutral position and is configured to grip the support.

18. The method of claim 16, further comprising connecting an insulative sleeve to the cable hanger, the insulative sleeve configured to limit conduction of electrical current.

19. The method of claim 16, wherein the first section, the second section, and the intermediate section are integrally formed as a one-piece construction.

20. The method of claim 16, wherein the second section includes a first vertical rod, a second vertical rod parallel to the first vertical rod, a first connecting rod that extends between the first vertical rod and the second vertical rod, and an inclined rod formed as a cantilever member from the second vertical rod, wherein the inclined rod includes a hook, the method further comprising:
moving the inclined rod toward the first vertical rod; and
securing the hook around the first vertical rod to form a closed perimeter;
wherein the closed perimeter is configured to limit removal of the cables from the second section.

21.-33. (canceled)
